(19) United States
(12) Patent Application Publication
(10) Pub. No.: US 2026/0167840 A1
(43) Pub. Date: Jun. 18, 2026

(54) METHOD OF PRODUCING A BUILDING PANEL AND A BUILDING PANEL

(71) Applicant: Välinge Innovation AB, Viken (SE)

(72) Inventors: Göran ZIEGLER, VIKEN (SE); Rickard RITTINGE, VIKEN (SE)

(73) Assignee: Välinge Innovation AB, Viken (SE)

(21) Appl. No.: 19/419,572

(22) Filed: Dec. 15, 2025

(30) Foreign Application Priority Data
Dec. 16, 2024 (SE) 2451292-3

(51) Int. Cl. C09D 15/00; B32B 21/04; B32B 21/14; C09D 5/03; C09D 7/40; C09D 7/61; C09D 7/65; C09D 161/28

(52) U.S. Cl. CPC C09D 15/00; B32B 21/042; B32B 21/14; C09D 5/031; C09D 7/61; C09D 7/65; C09D 7/70; C09D 161/28; B32B 2255/08; B32B 2255/26; B32B 2264/302

(57) ABSTRACT

A method for producing a building panel is provided. The method comprises providing a substrate (1), providing a front-layer mix (3) comprising a thermosetting binder in powder form and unreacted urea in powder form, applying said front-layer mix (7) on a front surface (4) of the substrate (1), thereby forming a front layer (2), and thereafter applying heat and pressure to the front layer (2) and the substrate (1), thereby at least partially curing the thermosetting binder and the urea, to form said building panel. A building panel is also provided. Additionally, use of unreacted urea as a formaldehyde scavenger in production of building materials, such as building panels, is provided.

### CROSS REFERENCE TO RELATED APPLICATIONS

The present application claims the benefit of Swedish Application No. SE 2451292-3, filed on Dec. 16, 2024. The entire contents of Swedish Application No. SE 2451292-3 are hereby incorporated herein by reference in their entirety.

### TECHNICAL FIELD

The present disclosure relates to a method of producing a building panel, such as a floor panel, and to such building panel.

### TECHNICAL BACKGROUND

Several technologies are used to provide a floor panel, which is a copy of a solid floor panel. The reason is that copies may be produced more cost efficiently and a floor with a separate layer attached to a core of for example HDF or plywood is more moisture stable than solid wood floors.

Wood fiber based direct pressed laminated flooring usually comprises a core of a fiber board, an upper decorative surface layer of laminate and a lower balancing layer of laminate, plastic, paper or like material.

A laminate surface generally comprises two paper sheets, a printed decorative paper and a transparent overlay intended to protect the decorative paper from abrasion. The printed decorative paper and the overlay are impregnated with melamine resin and laminated to a wood fiber-based core under heat and pressure.

Other common surface materials are wood veneer and foils, which are glued to a core. The surface may also be a powder layer comprising wood fibers, binders, color pigments and wear resistant particles.

Wood veneers may provide the most natural copies. The disadvantage is that a wood veneer generally has a lower impact resistance than laminate floors and the production cost is high when high quality veneers are used. A wood veneer may be pressed on a powder layer and such powder layer may provide increased impact resistance.

In WO 2009/065769 a flooring and a process for manufacturing the flooring are described, where a substantially homogenous powder mix of fibers, binders and wear resistant particles, referred to as WFF (Wood Fiber Floor), is applied on a wood-based panel such as MDF or HDF. A thin surface layer, such as a wood veneer layer, can be applied on the wood-based powder layer. The veneer layer is laminated to the wood-based panel under heat and pressure.

The binder of the powder mix described in WO 2009/065769 is e.g. a formaldehyde-based binder, e.g. a melamine formaldehyde-based binder. Melamine-formaldehyde binders are robust and highly durable thermosetting binders, that are vastly used within the flooring industry.

A problem is that formaldehyde is considered harmful. Formaldehyde is known to be carcinogenic to humans and harmful to the environment and is under increased legislative pressure. Formaldehyde emissions from flooring products may be a problem for workers during manufacturing, but also emissions from finished floorings may sometimes be considered as a health risk to consumers. The growing environmental concerns and stringent legislative requirements to the formaldehyde emissions from wood-based panels poses new challenges to researchers and the industry, related to the development of sustainable, eco-friendly wood-based panels, with very low formaldehyde emission. One solution to the problem is to use binders with no added formaldehyde (NAF binders). However, there are still substantial challenges for the complete replacement of formaldehyde-based binders with NAF binders, such as the relatively low bonding strength, poor water resistance, poor water permeability etc. of NAF binders.

Formaldehyde emissions may also be reduced by modifying formaldehyde-comprising binders, for example by adjusting the composition of the binder. By increasing the molar ratio melamine/formaldehyde when making a melamine-formaldehyde resin, the formaldehyde emission from the pressing process may be reduced. However, this approach may be associated with certain problems. If the melamine content is increased, excess, free melamine may be emitted. As melamine is listed on the candidate list under REACH (the European registration, evaluation, authorization and restriction of chemicals), this is not advantageous due to the likelihood of future restrictions. Another way to reduce formaldehyde emissions from formaldehyde-comprising binders is to use formaldehyde scavengers (formaldehyde catchers). Both synthetic scavengers, bio-based scavengers and nano-scavengers are known.

Liquid urea is one of the most frequently used formaldehyde scavengers. It is typically added to liquid formaldehyde-containing adhesives, which are frequently used in the manufacturing of particle boards. However, there is a need for an effective method to reduce formaldehyde emissions also from processes where binders in powder form are used. In production of building panels, thermosetting binders, for example melamine-formaldehyde resins, are typically added in powder form. This is advantageous for practical reasons, as binders in powder form are easy to apply evenly and have a considerably better storage stability than liquid binders.

From the above it is understood that there is room for improvements, and the present disclosure claims to solve or at least mitigate the above and other problems.

### SUMMARY

An overall objective of embodiments of the present disclosure is to provide an improvement over the above-described techniques and known art.

It is an objective of at least embodiments of the present disclosure to provide an improved method for producing a building panel comprising a thermosetting resin, and such a building panel.

Along with their numerous advantages, such as high reactivity, excellent adhesive performance and durability, thermosetting binders may also be associated with certain problems, in relation to the hazardous free formaldehyde released during pressing of the building panels and the formaldehyde emissions from finished building panels. Free formaldehyde is known to be carcinogenic to humans and harmful to the environment.

One way to decrease formaldehyde emissions from thermosetting binders during production of building panels and from finished building panels is to use formaldehyde scavengers. Liquid urea is one of the most frequently used formaldehyde scavengers. It is typically added to liquid formaldehyde-containing adhesives, used in the manufacturing of particle boards.

When producing building panels, thermosetting resins are nowadays often applied in powder form, which is more practical than application of the resin in liquid form. Mixing liquid urea with a thermosetting binder in powder form and obtaining a homogenous mix is difficult. There is thus a need for an effective method for producing building panels, wherein thermosetting binders are applied in powder form and wherein the emission of formaldehyde is reduced, compared to conventional methods. It is an objective of embodiments of the present disclosure to provide a method for producing a building panel, the method comprising applying a thermosetting binder in powder form, wherein the emission of formaldehyde during the production is decreased, compared to known production methods.

In a first aspect, a method for producing a building panel is provided. The building panel may preferably be a floor panel, a wall panel, a furniture component or similar. The method comprises providing a substrate; providing a front-layer mix comprising a thermosetting binder in powder form and urea in powder form; applying said front-layer mix on a front surface of the substrate, thereby forming a front layer; and after the applying of said front-layer mix, applying heat and pressure to the front layer and the substrate, thereby at least partially curing the thermosetting binder and the urea, to form said building panel. The front-layer mix may preferably comprise unreacted urea. In the scope of the present disclosure, unreacted urea refers to urea that is not chemically bound to any other substance or in any other way hindered, such as by encapsulation, to bind free formaldehyde. At least 95% by weight, such as at least 98% or at least 99% by weight of the urea in the front-layer mix may be unreacted. The front-layer mix may preferably comprise unreacted urea, so that the unreacted urea can bind free formaldehyde.

The front-layer mix may be a powder, such as a dry powder. The front-layer mix may have a moisture content of less than 3% by weight, such as less than 2% by weight or 1.5-3% by weight. The front-layer mix may be applied in powder form. A powder herein refers to a material composed of fine, loose particles. If applied in powder form, the surface area of the particles may be maximized, and chemical reactions may occur faster and more effectively. Alternatively, the front-layer mix may be applied as a granulate. A granulate herein refers to powder particles that are agglomerated into larger, free-flowing particles. The powder particles inside the agglomerated, larger, free-flowing particles may have the same size as the powder particles in powder form. A granulate may be easier to handle than a powder. The risk for segregation of different kinds of particles within a mixture may be reduced if the mixture is applied as a granulate. The risk for dust formation may be reduced if the mixture is applied as a granulate.

The thermosetting binder in the front-layer mix may comprise an amino resin. The thermosetting binder in the front-layer mix may comprise one or more of a melamine-formaldehyde resin, a urea-formaldehyde resin, a melamine-urea-formaldehyde resin, a melamine-phenol-formaldehyde resin, a urea-phenol formaldehyde resin, a melamine-urea-phenol-formaldehyde resin or combinations thereof. The thermosetting binder in the front-layer mix may comprise a melamine-formaldehyde resin.

By applying heat and pressure to the front layer and the substrate, the thermosetting binder and the urea are at least partially cured.

By mixing urea in powder form with the thermosetting binder in powder form, urea may react with and bind free formaldehyde that is released in the pressing and heating step, forming urea-formaldehyde adducts. The urea-formaldehyde adducts may then react with the molecules of the thermosetting binder and form new copolymers comprising urea residues, formaldehyde residues and residues of the thermosetting binder. Thus, the formaldehyde is not free anymore and the emissions of formaldehyde in the pressing step can be considerably reduced.

The curing may comprise the reaction of urea and formaldehyde forming urea-formaldehyde adducts.

The curing may comprise the reaction of urea-formaldehyde adducts and melamine-formaldehyde resin forming copolymers comprising melamine-residues, formaldehyde-residues and urea-residues.

The method may further comprise applying a front-layer veneer on the front layer. The step of applying heat and pressure then comprises applying heat and pressure to the front-layer veneer, the front layer and the substrate.

The front-layer veneer may be selected from one or more of a wood veneer, an impregnated paper, an unimpregnated paper, and a fabric such as a woven or a nonwoven fabric.

It has now surprisingly been shown by the present inventors that by using urea particles of a particular particle size and concentration, the formaldehyde-scavenging effect of the urea can be increased and, hence, the emission of free formaldehyde during production of the building panel and from the finished building panel may be significantly decreased.

The front-layer mix may comprise urea with an average particle size of less than 1000 mm, such as less than 500 mm, less than 250 mm, less than 100 mm or less than 50 mm, wherein average particle size is measured with sieving analysis in accordance with ISO 2591-1.

The front-layer mix may comprise urea with an average particle size of 0-1000 mm, such as 0-500 mm, 0-250 mm, 0-100 mm or 0-50 mm, wherein average particle size is measured with sieving analysis in accordance with ISO 2591-1.

At least 99% by weight of the urea in the front-layer mix (7) may have a particle size of less than 1000 mm, optionally at least 98% by weight of the urea in the front-layer mix (7) may have a particle size of less than 500 mm and/or at least 95% by weight of the urea in the front-layer mix (7) may have a particle size of less than 250 mm, wherein particle size is determined with sieving analysis in accordance with ISO 2591-1.

All or substantially all the urea in the front-layer mix may have a particle size of less than 500 mm, wherein particle size is determined with sieving analysis in accordance with ISO 2591-1.

The formaldehyde scavenging effect of the urea in the front-layer mix is increased as the concentration of urea increases. However, if the concentration of urea in the front-layer mix is increased too much, this will cause some of the technical properties of the building panel, like moisture resistance, to be impaired. The front-layer mix may comprise 0.1-10%, such as 0.5-8%, 1-6% or 2-5% by weight of urea.

The front-layer mix may comprise 20-70%, such as 30-60%, or 40-50% by weight of thermosetting binder.

The weight ratio between the urea and the thermosetting binder in the front-layer mix may be between 1:8 and 1:20, preferably between 1:10 and 1:15, more preferably between 1:11 and 1:12 and even more preferably approximately 1:11.4. These ratios can advantageously provide reduced emission of formaldehyde, while providing suitable structural integrity and a visually appealing design of the building panel.

The front-layer mix may comprise one or more additives and/or fillers. The front-layer mix may comprise one or more of fillers, pigments, wear-resistant particles, lignocellulosic materials, and other additives. The lignocellulosic materials may be one or more of wood fibers, hemp, grass, flax, straw and/or bagasse. The wood fibers are preferably made from recycled wood or wood waste. The wood fibers may come from old used-up wood building panels such as furniture, flooring or building elements. The wood waste may come from various wood handling processes such as furniture, flooring, or building production processes.

The front-layer mix may comprise 10-60%, such as 20-50%, or 35-45% by weight of lignocellulosic material, such as wood fibers, hemp, grass, flax, straw and/or bagasse.

The substrate may be a wood-based board, a polymer-based board, a mineral-based board, a textile-based board, or a combination thereof.

A wood-based board may for example be an MDF board, a HDF board, a plywood, or a particle board.

Building panels comprising a wood veneer or wood powder will inherently absorb moisture from the surroundings, causing swelling and shrinking of the building panel, which may result in deformation of the building panel. If the amount of swelling differs between the first and second surfaces of the building panel, the panel will be concave in cross section, i.e. the building panel will experience cupping. Melamine-formaldehyde resins in itself cause shrinkage, or pulling forces acting on a veneered building panel, which may add on to the cupping of the product. In order to avoid this, a balancing, or counteracting, layer may be provided on a surface of the substrate being opposite the surface on which the front layer and optionally the front-layer veneer layer is provided. The balancing, or counteracting, layer may preferably comprise the same layers as provided on the opposite side of the substrate, or at least preferably comprise the same binder as provided on the opposite side of the substrate.

The method may further comprise applying a backing-layer mix to a back surface of the substrate opposite the front surface on which the front-layer mix is applied, thereby forming a backing layer; and after the applying of said backing-layer mix, applying heat and pressure to the front layer, the substrate and the backing layer. The backing-layer mix may be applied as a powder. The backing-layer mix may be applied as a granulate. The backing-layer mix may comprise a thermosetting binder in powder form and urea in powder form. The backing-layer mix may preferably comprise unreacted urea. 95% by weight, such as 98% or 99% of the urea in the backing-layer mix may be unreacted. The backing-layer mix may preferably comprise unreacted urea, such that the urea can bind free formaldehyde.

A binder in the backing-layer mix may be the same as a binder in the front-layer mix.

The backing-layer mix may comprise urea with an average particle size of less than 1000 mm, such as less than 500 mm, less than 250 mm, less than 100 mm or less than 50 mm, wherein average particle size is measured with sieving analysis in accordance with ISO 2591-1.

The backing-layer mix may comprise urea with an average particle size of 0-1000 mm, such as 0-500 mm, 0-250 mm, 0-100 mm or 0-50 mm, wherein average particle size is measured with sieving analysis in accordance with ISO 2591-1.

At least 99% by weight of the urea in the backing-layer mix may have a particle size of less than 1000 mm, optionally at least 98% by weight of the urea in the backing-layer mix may have a particle size of less than 500 mm and/or at least 95% by weight of the urea in the backing-layer mix may have a particle size of less than 250 mm, wherein particle size is determined with sieving analysis in accordance with ISO 2591-1.

All or substantially all of the urea in the backing-layer mix may have a particle size of less than 500 mm, wherein particle size is determined with sieving analysis in accordance with ISO 2591-1.

The formaldehyde scavenging effect of the urea in the backing-layer mix is increased as the concentration of urea increases. However, if the concentration of urea in the backing-layer mix is increased too much, this will cause some of the technical properties of the building panel, like moisture resistance, to be impaired. The backing-layer mix may comprise 0.1-10%, such as 0.5-8%, 1-6% or 2-5% by weight of urea.

The backing-layer mix may comprise 20-70%, such as 30-60%, or 40-50% by weight of thermosetting binder.

The weight ratio between the urea and the thermosetting binder in the backing-layer mix may be between 1:8 and 1:20, preferably between 1:10 and 1:15, more preferably between 1:11 and 1:12 and even more preferably approximately 1:11.4. These ratios can advantageously provide reduced emission of formaldehyde, while providing suitable structural integrity and a visually appealing design of the building panel.

The backing-layer mix may comprise one or more additives and/or fillers. The backing-layer mix may comprise one or more of fillers, pigments, wear-resistant particles, lignocellulosic materials, and other additives. The lignocellulosic materials may be one or more of wood fibers, hemp, grass, flax, straw and/or bagasse. The wood fibers are preferably made from recycled wood or wood waste. The wood fibers may come from old used-up wood building panels such as furniture, flooring or building elements. The wood waste may come from various wood handling processes such as furniture, flooring, or building production processes.

The backing-layer mix may comprise 10-60%, such as 20-50%, or 35-45% by weight of lignocellulosic material, such as wood fibers, hemp

The method may further comprise applying a backing-layer veneer on the backing layer, wherein applying heat and pressure comprises applying heat and pressure to the front layer, the substrate, the backing layer and the backing-layer veneer.

The backing-layer veneer may be selected from one or more of a wood veneer, an impregnated paper, an unimpregnated paper, and a fabric such as a woven or a nonwoven fabric.

The step of heating and pressing may be performed by a continuous press.

The step of heating and pressing may be performed by a static press.

The pressure applied in the heating and pressing step may be at least 5 bar, preferably about 30-60 bar, or about 35-55 bar. The pressure may be applied during at least 10 s, preferably during 20-40 s. The temperature applied in the heating and pressing step may be 100-250° C., such as 180-220° C. A temperature of at least 150° C., such as at least 180° C., may be applied. The temperature may depend on which binder is used. Also, the temperature may depend on the speed of the production line in a continuous press or the press time of a static press.

In a second aspect, a building panel produced with the method according to the first aspect is provided.

In addition to reducing the emission of formaldehyde during production of a building panel according to the first aspect, the emission of formaldehyde from the finished building panel is also lowered. It is an objective of embodiments of the present disclosure to provide a building panel comprising a thermosetting resin, wherein the emission of formaldehyde from the finished building panel is decreased, compared to known building panels comprising thermosetting resins.

In a third aspect, a building panel is provided. The building panel comprises a substrate and a front layer arranged on a front surface of the substrate. The front layer comprises melamine-residues, formaldehyde-residues and urea-residues. The melamine-residues, formaldehyde-residues and urea-residues are at least partially polymerized.

The building panel may be a floor panel, a wall panel, a furniture component or similar.

The building panel may additionally comprise a front-layer veneer arranged on the front layer. The front-layer veneer may be selected from one or more of a wood veneer, an impregnated paper, an unimpregnated paper, and a fabric such as a woven or a nonwoven fabric.

The building panel may additionally comprise a backing layer arranged on a back surface of the substrate. The backing layer may comprise melamine-derivatives, formaldehyde-derivatives and urea-derivatives. The melamine-derivatives, formaldehyde-derivatives and urea-derivatives may be at least partially polymerized.

A binder in the front layer may be the same as a binder in the backing layer.

The backing layer may additionally comprise a backing-layer veneer arranged on the backing layer. The backing-layer veneer may be selected from one or more of a wood veneer, an impregnated paper, an unimpregnated paper, and a fabric such as a woven or a nonwoven fabric.

To help consumers make environmentally conscious choices, the U.S.

Environmental Protection Agency has established formaldehyde emission standards for different products, as part of the Toxic Substances Control Act (TSCA).

To be classified as an ultra-low emitting formaldehyde (ULEF) product according to TSCA, Title VI (2018), there are different formaldehyde emission limits for different composite wood products. For example, the formaldehyde emission limit is 0.05 ppm for a hardwood plywood product, 0.09 ppm for a particle board product, 0.11 ppm for a product comprising an MDF board with a thickness of more than 8 mm and 0.13 ppm for a product comprising an MDF board with a thickness of less than or equal to 8 mm. The formaldehyde emission limits refer to formaldehyde emission as measured in accordance with ASTM 1333. A veneered building panel comprising a wooden core is classified as an ultra-low emitting formaldehyde (ULEF) hardwood plywood, if the emission of formaldehyde from the panel is less than 0.05 ppm, as measured in accordance with ASTM 1333. It is an objective of embodiments of the present disclosure to provide a building panel wherein the building panel comprises a front-layer veneer, and wherein the formaldehyde emission from the building panel, as measured in accordance with ASTM 1333, is less than 0.05 ppm.

It is further on an objective of embodiments of the present disclosure to provide a building panel that is classified as an ultra-low emitting formaldehyde (ULEF) hardwood plywood according to TSCA, Title VI (2018). It is an objective of embodiments of the present disclosure to provide a building panel that is classified as an ultra-low emitting formaldehyde (ULEF) particle board according to TSCA, Title VI (2018) and it is an objective of embodiments of the present disclosure to provide a building panel that is classified as an ultra-low emitting formaldehyde (ULEF) MDF board according to TSCA, Title VI (2018).

The formaldehyde emission from the building panel according to embodiments of the present disclosure may be less than 0.05 ppm, as measured in accordance with ASTM 1333.

A veneered building panel according to embodiments of the present disclosure may be classified as an ultra-low emitting formaldehyde hardwood plywood, in accordance with TSCA, Title VI (2018).

Experiments have proved that the particle size of the urea particles used in the method according to the first aspect is important for reduction of formaldehyde emissions from building panels according to the second and third aspects. Further on, the appearance of the finished building panels is also affected by the particle size of the urea used to produce the building panel. By choosing the appropriate particle size of the urea powder, particles and/or aggregates of urea causing discoloration of the building panel can be avoided. Such discolorations may be seen as white spots on building panels without a veneer and in open structures of veneered building panels and as dark spots under the veneer of veneered panels. Another objective of embodiments of the present disclosure is to provide a building panel that is substantially free from discolorations from urea particles and/or urea aggregates.

According to embodiments of the present disclosure, the front layer and/or the front-layer veneer of the building panel may be substantially free from discolorations from urea particles and/or urea aggregates.

According to experiments presented in the present disclosure, building panels produced with the method according to the first aspect, and utilizing a melamine-formaldehyde resin and unreacted urea in powder form, have an improved Brinell hardness compared to building panels produced with a melamine-formaldehyde resin without any added urea. It is an objective of embodiments of the present disclosure to provide a building panel that has an improved hardness compared to conventionally produced building panels.

Further on, experiments presented herein have proved that a melamine-formaldehyde binder resin comprising urea has a higher resin flow than a melamine formaldehyde resin without urea. A technical effect of this may be that open structures in a veneer layer, such as knots and holes, can more easily be filled with resin from the binder layer. An effect of the improved resin flow may be that a lower amount of resin can be applied in the binder layer, while open structures of the veneer layer may still be filled with resin satisfactory. This means that less resin can be used, which is beneficial both from an environmental perspective and from an economical perspective. It is an object of embodiments of the present disclosure to provide a method for producing a building panel that is environmentally and/or economically beneficial compared to conventional methods for producing building panels.

In a fourth aspect, use of urea as a formaldehyde scavenger in production of building materials, such as building panels, is provided. The urea may preferably be unreacted. The urea may be provided in powder form and may have an average particle size of less than 1000 mm, such as less than 500 mm, less than 250 mm, less than 100 mm, or less than 50 mm, wherein average particle size is determined with sieving analysis in accordance with ISO 259-1. The urea may have an average particle size of 0-1000 mm, such as 0-500 mm, 0-250 mm, 0-100 mm or 0-50 mm and wherein average particle size is determined with sieving analysis in accordance with ISO 2591-1. At least 99% by weight of the urea may have a particle size of less than 1000 mm, optionally at least 98% by weight of the urea may have a particle size of less than 500 mm and/or at least 95% by weight of the urea may have a particle size of less than 250 mm, wherein particle size is determined with sieving analysis in accordance with ISO 2591-1.

### BRIEF DESCRIPTION OF THE DRAWINGS

The present disclosure will by way of example be described in more detail with reference to the appended schematic drawings, which show illustrative embodiments of the present disclosure.

FIG. 1 shows a method of producing a building panel according to an embodiment of the present disclosure.

FIG. 2 shows a method of producing a building panel according to another embodiment of the present disclosure.

FIG. 3 shows a step of a method of producing a building panel according to embodiments of the present disclosure.

FIG. 4 is a flow chart of a method of producing a building panel according to an embodiment of the present disclosure.

FIG. 5 is a flowchart of a method of producing a building panel according to another embodiment of the present disclosure.

FIG. 6 is a building panel according to an embodiment of the present disclosure.

FIG. 7 is a building panel according to another embodiment of the present disclosure.

FIG. 8 is an illustration of a top view of a building panel with a mechanical locking device, according to an embodiment of the present disclosure.

FIG. 9 is an illustration of a cross section of a mechanical locking device in an assembled state arranged along opposite edges of two adjacent building panels, according to an embodiment of the present disclosure.

FIG. 10 is a graph illustrating the results of Example 1.

FIG. 11 shows a photograph of a veneered building panel with discolorations from urea, according to Example 3.

FIG. 12 shows photographs of the four building panels produced according to Example 5.

FIG. 13 is a graph illustrating the results of Example 6.

Further, in the figures like reference characters designate like or corresponding parts throughout the several figures.

### DETAILED DESCRIPTION OF EMBODIMENTS

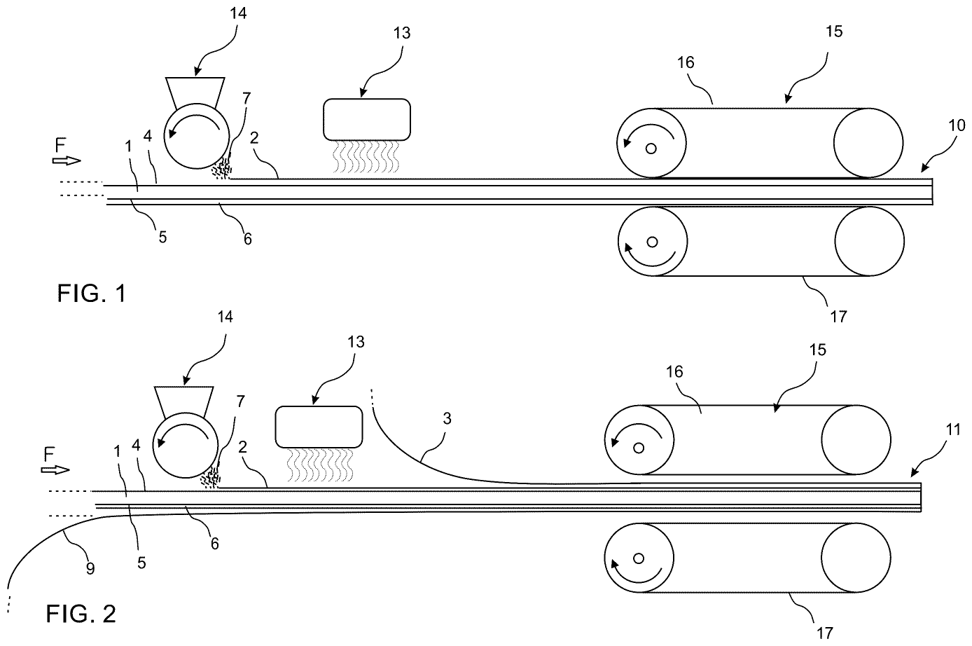

FIG. 1 illustrates an embodiment of a method for producing a building panel 10.

The building panel 10 may be, or form part of, a furniture component, a building panel such as a floor panel, a ceiling panel, a wall panel, a door panel, a worktop, skirting boards, moldings, edging profiles, etc.

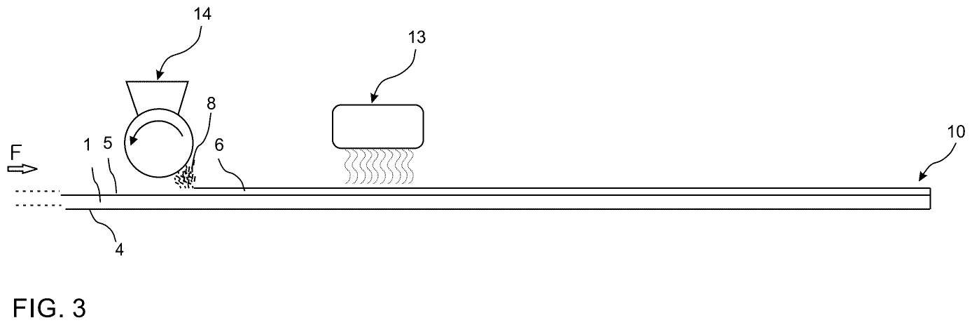

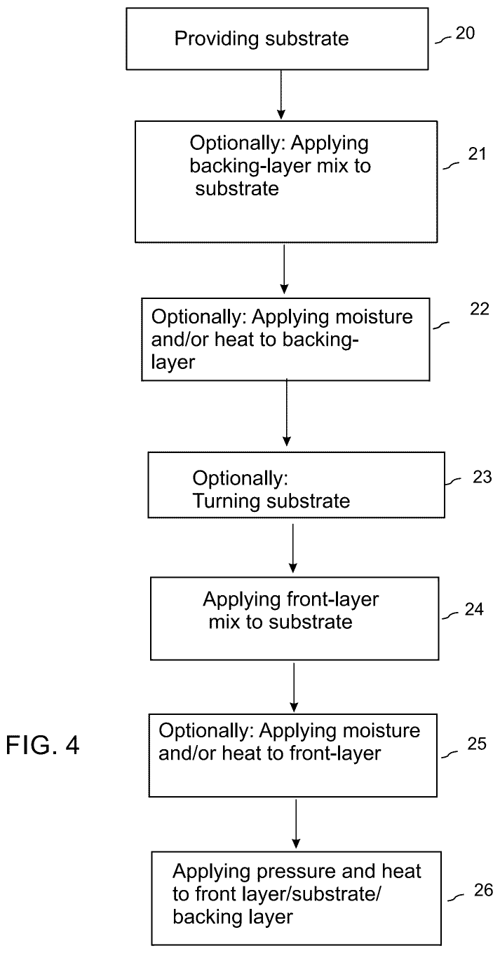

The method includes providing a substrate 1. The substrate 1 is moved in a direction F through a production line comprising several steps, which will be further described below with reference to FIG. 1, FIG. 3 and the flowchart of FIG. 4.

The substrate 1 is preferably a prefabricated substrate, produced prior to the method of producing the panel 10. The substrate 1 may be a board, for example, a wood-based board. The wood-based board may be an MDF board, a HDF board, a plywood, a particle board or any other suitable wood-based board. Boards comprising other materials may also be used.

A front-layer mix 7 comprising a thermosetting binder in powder form and urea in powder form is provided. As shown in FIG. 1, the front-layer mix 7 is applied on a first surface 4 of the substrate 1, thereby forming a front layer 2. The front-layer mix 7 may preferably comprise unreacted urea. 95% by weight, such as 98% or 99% of the urea in the front-layer mix 7 may be unreacted.

The front-layer mix 7 may be a powder, preferably a dry powder. The front-layer mix 7 may comprise less than 3% by weight moisture, such as 1.5-3% by weight or approximately 2% by weight. The front-layer mix 7 may be applied in powder form. The front-layer mix 7 may alternatively be applied as a granulate. If applied in powder form, the surface area of the particles in the front-layer mix 7 may be maximized, and chemical reactions may occur faster and more effectively. Alternatively, the front-layer mix 7 may be applied as a granulate. A granulate may comprise powder particles that are agglomerated into larger, free-flowing particles. The powder particles inside the agglomerated, larger, free-flowing particles may have the same size as the powder particles in powder form. A granulate may be easier to handle than a powder. The risk for segregation of different kinds of particles within a mixture may be reduced if the mixture is applied as a granulate. The risk for dust formation may be reduced if the mixture is applied as a granulate.

The front-layer mix 7 may be applied by scattering by means of a scatter device 14. The front-layer mix 7 may be applied in an amount of 10-500 g/m², such as 100-600 g/m², or 300-500 g/m². The front-layer mix 7 comprises a thermosetting binder and urea. The front-layer mix 7 may comprise an amino resin. The front-layer mix 7 may comprise one or more of a melamine-formaldehyde resin, a urea-formaldehyde resin, a melamine-urea-formaldehyde resin, a melamine-phenol-formaldehyde resin, a urea-phenol formaldehyde resin, a melamine-urea-phenol-formaldehyde resin or combinations thereof.

The front-layer mix 7 may comprise 20-70%, such as 30-60%, or 40-50% by weight of thermosetting binder.

In one embodiment, the front-layer mix 7 comprises urea with an average particle size of less than 1000 mm, such as less than 500 mm, less than 250 mm, less than 100 mm or less than 50 mm, wherein average particle size is measured with sieving analysis in accordance with ISO 2591-1.

In one embodiment, the front-layer mix 7 comprises urea with an average particle size of 0-1000 mm, such as 0-500 mm, 0-250 mm, 0-100 mm or 0-50 mm, wherein the average particle size of the urea has been determined with sieving analysis in accordance with ISO 2591-1.

In one embodiment, at least 99% by weight of the urea in the front-layer mix (7) may have a particle size of less than 1000 mm, optionally at least 98% by weight of the urea in the front-layer mix (7) may have a particle size of less than 500 mm and/or at least 95% by weight of the urea in the front-layer mix (7) may have a particle size of less than 250 mm, wherein particle size is determined with sieving analysis in accordance with ISO 2591-1.

All or substantially all the urea in the front-layer mix (7) may have a particle size of less than 500 mm, wherein particle size is determined with sieving analysis in accordance with ISO 2591-1.

The front-layer mix 7 may comprise 0.1-10%, such as 0.5-8%, or 1-6% or 2-5% by weight of urea. The formaldehyde scavenging effect of the urea in the front-layer mix 7 is increased as the concentration of urea is increased. However, if the concentration of urea in the front-layer mix 7 is increased too much, this will cause some of the technical properties of the building panel, like moisture resistance, to be impaired. Aggregates of urea may also cause problems in the production process, as aggregates of urea may stick to the pressing plate.

The weight ratio between the urea and the thermosetting binder in the front-layer mix 7 may be between 1:8 and 1:20, preferably between 1:10 and 1:15, more preferably between 1:11 and 1:12 and even more preferably approximately 1:11.4. These ratios can advantageously provide reduced emission of formaldehyde, while providing suitable structural integrity and a visually appealing design.

The front-layer mix 7 may comprise one or more additives and/or fillers. The front-layer mix 7 may comprise one or more of fillers, pigments, wear-resistant particles, lignocellulosic materials such as wood-fibers, and other additives. The wood-fibers are preferably made from recycled wood or wood waste. The wood-fibers may come from old used-up wood building panels such as furniture, flooring or building elements. The wood waste may come from various wood handling processes such as furniture, flooring, or building production processes. The lignocellulosic materials may also be one or more of hemp, grass, flax, straw and/or bagasse.

The front-layer mix 7 may comprise 10-60%, such as 20-50%, or 35-45% by weight of lignocellulosic material, such as wood fibers.

The method may comprise a step of applying heat by means of a heating device 13 to the front layer 2 as shown in FIG. 1 and in the flowchart of FIG. 4. The heat may be applied by any suitable type of heat source e.g. thermal radiation, such as IR radiation, and/or by microwaves, and/or by hot air. The front layer 2 may be heated without first applying moisture to the front layer 2 or moisture may be applied to the front layer 2 prior to applying heat to the front layer 2. The step of heating the front layer 2 serves to sinter particles of the binder in the front layer 2. For example, the sintered particles may form a contiguous mass. For example, the sintered particles of the front layer 2 may adhere to the substrate 1.

After applying the front-layer mix 7, heat and pressure are applied to the front layer 2 and the substrate 1, as illustrated in the flowchart of FIG. 4. Heat and pressure may be applied by a continuous press as shown in FIG. 1 or by a static press (not illustrated). As shown in the FIG. 1, the pressure may be applied by a continuous press 15, having an upper press belt 16 and a lower press belt 17. The pressure applied may be at least 5 bar, preferably about 30-60 bar, or about 35-55 bar. The pressure may be applied during at least 10 s, preferably during 20-40 s. The press 15 comprising e.g. either hot oil or electrical/induction heat is heated in order to apply heat together with pressure. A temperature of 100-250° C., such as 180-220° C., may be applied. A temperature of at least 150° C., such as at least 180° C., may be applied. The temperature may depend on which binder is used. Also, the temperature may depend on the speed of the production line in a continuous press or the press time of a static press.

When applying heat and pressure, the thermosetting binder and the urea of the front layer 2 are at least partially cured to form a building panel 10. The thermosetting binder and the urea of the front layer 2 may be cured by in-line polymerization, meaning that polymerization of components occurs in the production line, during production of the building panel.

As shown in FIG. 3, a backing-layer mix 8 may be applied to a second surface 5 of the substrate 1, opposite the first surface 4 on which the front layer 2 is applied, thereby forming a backing layer 6. For practical reasons, the backing-layer mix 8 is preferably applied to the second surface 5 of the substrate 1 prior to the application of the front-layer mix 7, as illustrated in the flowchart of FIG. 4. Heat and optionally also moisture may be applied to the backing-layer mix 8 to sinter the particles of the backing-layer mix 8. When the backing layer 6 has been applied to the substrate 1, the substrate 1 and the backing layer 6 are turned, whereafter the front-layer mix 7 is applied on the first surface 4 of the substrate 1, as illustrated in FIG. 1 and in the flowchart of FIG. 4. Turning the substrate 1 and the backing layer 6 is preferably done automatically.

The backing-layer mix 8 may comprise a thermosetting binder in powder form and urea in powder form. The backing-layer mix 8 may preferably comprise unreacted urea. 95% by weight, such as 98% or 99% of the urea in the backing-layer mix 8 may be unreacted.

The backing-layer mix 8 may be a powder, preferably a dry powder. The backing-layer mix 8 may comprise less than 3% by weight moisture, such as 1.5-3% by weight or approximately 2% by weight. The backing-layer mix 8 may be applied in powder form. The backing-layer mix 8 may alternatively be applied as a granulate. If applied in powder form, the surface area of the particles in the backing-layer mix 8 may be maximized, and chemical reactions may occur faster and more effectively. Alternatively, the backing layer mix 8 may be applied as a granulate. A granulate may comprise powder particles that are agglomerated into larger, free-flowing particles. The powder particles inside the agglomerated, larger, free-flowing particles may have the same size as the powder particles in powder form. A granulate may be easier to handle than a powder. The risk for segregation of different kinds of particles within a mixture may be reduced if the mixture is applied as a granulate. The risk for dust formation may be reduced if the mixture is applied as a granulate.

The backing-layer mix 8 may be applied by scattering by means of a scatter device 14. The backing-layer mix 8 may be applied in an amount of 10-500 g/m², such as 100-600 g/m², or 300-500 g/m². The backing-layer mix 8 preferably comprises a thermosetting binder and urea. The backing-layer mix 8 may comprise an amino resin. The backing-layer mix 8 may comprise one or more of a melamine-formaldehyde resin, a urea-formaldehyde resin, a melamine-urea-formaldehyde resin, a melamine-phenol-formaldehyde resin, a urea-phenol formaldehyde resin, a melamine-urea-phenol-formaldehyde resin or combinations thereof.

The backing-layer mix 8 may comprise 20-70%, such as 30-60%, or 40-50% by weight of a thermosetting binder.

The backing-layer mix 8 may comprise a binder that is the same as a binder in the front-layer mix 7.

The backing-layer mix 8 may comprise urea with an average particle size of less than 1000 mm, such as less than 500 mm, less than 250 mm, less than 100 mm or less than 50 mm, wherein average particle size is measured with sieving analysis in accordance with ISO 2591-1.

The backing-layer mix 8 may comprise urea with an average particle size of 0-1000 mm, such as 0-500 mm, 0-250 mm, 0-100 mm or 0-50 mm, wherein average particle size is measured with sieving analysis in accordance with ISO 2591-1.

At least 99% by weight of the urea in the backing-layer mix 8 may have a particle size of less than 1000 mm, optionally at least 98% by weight of the urea in the backing-layer mix 8 may have a particle size of less than 500 mm and/or at least 95% by weight of the urea in the backing-layer mix 8 may have a particle size of less than 250 mm, wherein particle size is determined with sieving analysis in accordance with ISO 2591-1.

All or substantially all the urea in the backing-layer mix 8 may have a particle size of less than 500 mm, wherein particle size is determined with sieving analysis in accordance with ISO 2591-1.

The backing-layer mix 8 may comprise 0.1-10%, such as 0.5-8%, or 1-6% or 2-5% by weight of urea. The formaldehyde scavenging effect of the urea in the backing-layer mix 8 is increased as the concentration of urea is increased. However, if the concentration of urea in the backing-layer mix 8 is increased too much, this will cause some of the technical properties of the building panel, like moisture resistance, to be impaired. Aggregates of urea may also cause problems in the production process, as aggregates of urea may stick to the pressing plate.

The weight ratio between the urea and the thermosetting binder in the backing-layer mix 8 may be between 1:8 and 1:20, preferably between 1:10 and 1:15, more preferably between 1:11 and 1:12 and even more preferably approximately 1:11.4. These ratios can advantageously provide reduced emission of formaldehyde, while providing suitable structural integrity and a visually appealing design.

The backing-layer mix 8 may comprise one or more additives and/or fillers. The backing-layer mix 8 may comprise one or more of fillers, pigments, wear-resistant particles, lignocellulosic materials such as wood-fibers, and other additives. The wood-fibers are preferably made from recycled wood or wood waste. The wood-fibers may come from old used-up wood building panels such as furniture, flooring or building elements. The wood waste may come from various wood handling processes such as furniture, flooring, or building production processes. The lignocellulosic materials may also be one or more of hemp, grass, flax, straw and/or bagasse.

The backing-layer mix 8 may comprise 10-60%, such as 20-50%, or 35-45% by weight of lignocellulosic material, such as wood fibers.

After applying the front-layer mix 7 and the backing-layer mix 8, heat and pressure are applied to the front layer 2, the backing layer 6 and the substrate 1, as illustrated in the flowchart of FIG. 4. Heat and pressure may be applied by a continuous press as shown in FIG. 1 or by a static press (not illustrated). As shown in the FIG. 1, the pressure may be applied by a continuous press 15, having an upper press belt 16 and a lower press belt 17. The pressure applied may be at least 5 bar, preferably about 30-60 bar, or about 35-50 bar. The pressure may be applied during at least 10 s, preferably during 20-40 s. The press 15 comprising e.g. either hot oil or electrical/induction heat is heated in order to apply heat together with pressure. A temperature of 100-250° C., such as 180-220° C., may be applied. A temperature of at least 150° C., such as at least 180° C., may be applied. The temperature may depend on which binder is used. Also, the temperature may depend on the speed of the production line in a continuous press or the press time of a static press.

When applying heat and pressure, the thermosetting binder and the urea of the front layer 2 and the components of the backing layer 6 are at least partially cured to form a building panel 10.

The thermosetting binder and the urea of the front layer 2 and the components of the backing layer 6 may be cured by in-line polymerization, meaning that polymerization of components occurs in the production line, during production of the building panel.

FIG. 2 illustrates an embodiment of a method for producing a veneered building panel 11.

The veneered building panel 11 may be, or form part of, a furniture component, a building panel such as a floor panel, a ceiling panel, a wall panel, a door panel, a worktop, skirting boards, moldings, edging profiles, etc.

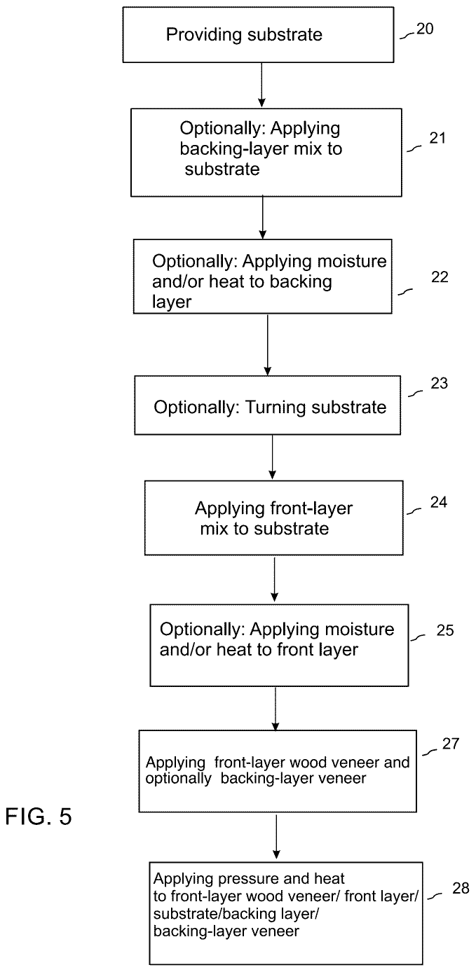

The method includes providing a substrate 1. The substrate 1 is moved in a direction F through a production line comprising several steps, which will be further described below with reference to FIG. 2, FIG. 3 and the flowchart of FIG. 5.

The substrate 1 is preferably a prefabricated substrate, produced prior to the method of producing the veneered building panel 11. The substrate 1 may be a board, for example, a wood-based board. The wood-based board may be an MDF board, a HDF board, a plywood, a particle board or any other suitable wood-based board. Boards comprising other materials may also be used.

A front-layer mix 7 comprising a thermosetting binder in powder form and urea in powder form is provided. The front-layer mix 7 may be as described in relation to the embodiment illustrated in FIG. 1, whereby reference is made thereto.

The front-layer mix 7 may preferably comprise unreacted urea. In the scope of the present disclosure, unreacted urea refers to urea that is not chemically bound to any other substance or in any other way hindered, such as by encapsulation, to bind free formaldehyde. 95% by weight, such as 98% or 99% of the urea in the front-layer mix 7 may be unreacted. The front-layer mix 7 may be a powder, preferably a dry powder. The front-layer mix 7 may comprise less than 3% by weight moisture, such as 1.5-3% by weight or approximately 2% by weight.

As shown in FIG. 2, the front-layer mix 7 is applied on a first surface 4 of the substrate 1, thereby forming a front layer 2. The front-layer mix 7 may be applied in powder form. The front-layer mix 7 may also be applied as a granulate. The front-layer mix 7 may be applied by scattering by means of a scatter device 14. The front-layer mix 7 may be applied in an amount of 10-1000 g/m², such as 100-600 g/m², or 300-500 g/m². The front-layer mix 7 comprises a thermosetting binder and urea. The front-layer mix 7 may comprise an amino resin. The front-layer mix 7 may comprise one or more of a melamine-formaldehyde resin, a urea-formaldehyde resin, a melamine-urea-formaldehyde resin, a melamine-phenol-formaldehyde resin, a urea-phenol formaldehyde resin, a melamine-urea-phenol-formaldehyde resin or combinations thereof.

The front-layer mix 7 may comprise 20-70%, such as 30-60%, or 40-50% by weight of thermosetting binder.

In one embodiment, the front-layer mix 7 comprises urea with an average particle size of less than 1000 mm, such as less than 500 mm, less than 250 mm, less than 100 mm or less than 50 mm, wherein average particle size is measured with sieving analysis in accordance with ISO 2591-1.

In one embodiment, the front-layer mix 7 comprises urea with an average particle size of 0-1000 mm, such as 0-500 mm, 0-250 mm, 0-100 mm or 0-50 mm, wherein average particle size is determined with sieving analysis in accordance with ISO 2591-1.

At least 99% by weight of the urea in the front-layer mix 7 may have a particle size of less than 1000 mm, optionally at least 98% by weight of the urea in the front-layer mix 7 may have a particle size of less than 500 mm and/or at least 95% by weight of the urea in the front-layer mix 7 may have a particle size of less than 250 mm, wherein particle size is determined with sieving analysis in accordance with ISO 2591-1.

All or substantially all the urea in the front-layer mix 7 may have a particle size of less than 500 mm, wherein particle size is determined with sieving analysis in accordance with ISO 2591-1.

The front-layer mix 7 may comprise 0.1-10%, such as 0.5-8%, 1-6% or 2-5% by weight of urea. The formaldehyde scavenging effect of the urea in the front-layer mix 7 is increased as the concentration of urea is increased. However, if the concentration of urea in the front-layer mix 7 is increased too much, this will cause some of the technical properties of the veneered building panel, like moisture resistance, to be impaired. Aggregates of urea may also cause problems in the production process. The front layer 2 may be exposed to the pressing plate through open structures like holes and knots, and aggregates of urea may stick to the pressing plate in these open structures.

The front-layer mix 7 may comprise one or more additives and/or fillers. The front-layer mix 7 may comprise one or more of fillers, pigments, wear-resistant particles, lignocellulosic materials such as wood-fibers, and other additives. The wood-fibers may preferably be made from recycled wood or wood waste. The wood-fibers may come from old used-up wood building panels such as furniture, flooring or building elements. The wood waste may come from various wood handling processes such as furniture, flooring, or building production processes. The lignocellulosic materials may also be one or more of hemp, grass, flax, straw and/or bagasse.

The front-layer mix 7 may comprise 10-60%, such as 20-50%, or 35-45% by weight of lignocellulosic material, such as wood fibers.

The method may comprise a step of applying heat by means of a heating device 13 to the front layer 2. The heat may be applied by any suitable type of heat source e.g. thermal radiation, such as IR radiation, and/or by microwaves, and/or by hot air. The front layer 2 may be heated without first applying moisture to the front layer 2 or moisture may be applied to the front layer 2 prior to applying heat to the front layer 2. The step of heating the front layer 2 serves to sinter particles of the binder in the front layer 2. For example, the sintered particles may form a contiguous mass. For example, the sintered particles of the front layer 2 may adhere to the substrate 1.

After applying the front-layer mix 7 on the substrate 1 and thereby forming a front layer 2, a front-layer veneer layer 3 is applied on the front layer 2, as shown in FIG. 2. The front-layer veneer 3 may be selected from one or more of a wood veneer, an impregnated paper, an unimpregnated paper, and a fabric such as a woven or a nonwoven fabric. The front-layer veneer 3 may also comprise open features such as holes and cracks. The front-layer veneer 3 may have a thickness of about 0.2-2.5 mm, such as 0.3-2.0 mm, or 0.4-1.0 mm.

The front-layer veneer 3 may be continuous or non-continuous. The front-layer veneer 3 may be formed of several veneer pieces, i.e., being non-continuous. The veneer pieces may be over-lapping or non-overlapping.

In a similar manner as described above, the front-layer mix 7 described above may be applied on a surface of the front-layer veneer 3 configured to face the substrate 1 and forming a front layer 2. Then, the front-layer veneer 3, with the front layer 2, may be applied on the first surface 4 of the substrate 1. The front-layer mix 7 may be applied both on the substrate 1 and on the front-layer veneer 3.

Thereafter, heat and pressure are applied. The thermosetting binder and the urea of the front layer 2 are at least partially cured to form a veneered building panel 11.

The thermosetting binder and the urea of the front layer 2 may be cured by in-line polymerization, meaning that polymerization of components occurs in the production line, during production of the building panel.

A backing-layer mix 8 may be applied to a second surface 5 of the substrate 1, opposite the first surface 4 on which the front-layer mix 7 is applied, thereby forming a backing layer 6. For practical reasons, the backing-layer mix 8 is preferably applied to the second surface 5 of the substrate 1 in a step occurring before the application of the front-layer mix 7, as illustrated in FIG. 3 and in the flowchart of FIG. 5. Heat and optionally also moisture may be applied to the backing-layer mix 8 to sinter the particles of the backing-layer mix 8. When the backing-layer mix 8 has been applied to the substrate 1, the substrate 1 and the backing layer 6 are turned, whereafter the front-layer mix 7 is applied on the first surface 4 of the substrate 1.

The backing-layer mix 8 may be as described in relation to the embodiment illustrated in FIG. 1, whereby reference is made thereto.

The backing-layer mix 8 may comprise a thermosetting binder in powder form and urea in powder form. The backing-layer mix 8 may preferably comprise unreacted urea. 95% by weight, such as 98% or 99% of the urea in the backing-layer mix 8 may be unreacted.

The backing-layer mix 8 may be a powder, preferably a dry powder. The backing-layer mix 8 may comprise less than 3% by weight moisture, such as 1.5-3% by weight or approximately 2% by weight. The backing-layer mix 8 may be applied in powder form. The backing-layer mix 8 may alternatively be applied as a granulate. The backing-layer mix 7 may be applied by scattering by means of a scatter device 14. The backing-layer mix 8 may be applied in an amount of 10-500 g/m², such as 100-600 g/m², or 300-500 g/m². The backing-layer mix 8 preferably comprises a thermosetting binder and urea. The backing-layer mix 8 may comprise an amino resin. The backing-layer mix 8 may comprise one or more of a melamine-formaldehyde resin, a urea-formaldehyde resin, a melamine-urea-formaldehyde resin, a melamine-phenol-formaldehyde resin, a urea-phenol formaldehyde resin, a melamine-urea-phenol-formaldehyde resin or combinations thereof.

The backing-layer mix 8 may comprise 20-70%, such as 30-60%, or 40-50% by weight of a thermosetting binder.

The backing-layer mix 8 may comprise a binder that is the same as a binder in the front-layer mix 7.

The backing-layer mix 8 may comprise urea with an average particle size of 0-1000 mm, such as 0-500 mm, 0-250 mm, 0-100 mm or 0-50 mm, wherein the average particle size of the urea has been determined with sieving analysis in accordance with ISO 2591-1.

The backing-layer mix 8 may comprise urea with an average particle size of less than 1000 mm, such as less than 500 mm, less than 250 mm, less than 100 mm or less than 50 mm, wherein particle size is measured with sieving analysis in accordance with ISO 2591-1.

At least 99% by weight of the urea in the backing-layer mix (8) may have a particle size of less than 1000 mm, optionally at least 98% by weight of the urea in the backing-layer mix 8 may have a particle size of less than 500 mm and/or at least 95% by weight of the urea in the backing-layer mix 8 may have a particle size of less than 250 mm, wherein particle size is determined with sieving analysis in accordance with ISO 2591-1.

All or substantially all the urea in the backing-layer mix 8 may have a particle size of less than 500 mm, wherein particle size is determined with sieving analysis in accordance with ISO 2591-1.

The backing-layer mix 8 may comprise 0.1-10%, such as 0.5-8%, or 1-6% or 2-5% by weight of urea. The formaldehyde scavenging effect of the urea in the backing-layer mix 8 is increased as the concentration of urea is increased. However, if the concentration of urea in the backing-layer mix 8 is increased too much, this will cause some of the technical properties of the building panel, like moisture resistance, to be impaired. Aggregates of urea may also cause problems in the production process, as aggregates of urea may stick to the pressing plate. The backing-layer mix 8 may comprise one or more additives and/or fillers. The backing-layer mix 8 may comprise one or more of fillers, pigments, wear-resistant particles, lignocellulosic materials such as wood-fibers, and other additives. The wood-fibers are preferably made from recycled wood or wood waste. The wood-fibers may come from old used-up wood building panels such as furniture, flooring or building elements. The wood waste may come from various wood handling processes such as furniture, flooring, or building production processes. The lignocellulosic materials may also be one or more of hemp, grass, flax, straw and/or bagasse.

The backing-layer mix 8 may comprise 10-60%, such as 20-50%, or 35-45% by weight of lignocellulosic material, such as wood fibers.

The method may further comprise applying a backing-layer veneer 9 on the backing layer 6. The backing layer veneer 9 may comprise one or more of a wood veneer, an impregnated paper, an unimpregnated paper, and a fabric such as a woven or a nonwoven fabric.

After applying the front-layer mix 7, the front-layer veneer 3 and optionally a backing-layer mix 8 and a backing-layer veneer 9, heat and pressure are applied to the front layer 2, the front-layer veneer 3, the backing layer 6, the backing-layer veneer 9 and the substrate 1. Heat and pressure may be applied by a continuous press, as shown in FIG. 2, or by a static press (not illustrated). As shown in the FIG. 2, the pressure may be applied by a continuous press 15, having an upper press belt 16 and a lower press belt 17. The pressure applied may be at least 5 bar, preferably about 30-60 bar, or about 35-55 bar. The pressure may be applied during at least 10 s, preferably during 20-40 s. The press 15 comprising e.g. either hot oil or electrical/induction heat is heated in order to apply heat together with pressure. A temperature of 100-250° C., such as 180-220° C. may be applied. A temperature of at least 150° C., such as at least 180° C., may be applied. The temperature may depend on which binder is used. Also, the temperature may depend on the speed of the production line in a continuous press or the press time of a static press. When applying pressure, the front layer 2 and the backing layer 6 are cured and a building panel 11 is formed.

When applying heat and pressure, the thermosetting binder and the urea of the front layer 2 are at least partially cured to form a veneered building panel 101 When applying heat and pressure, the backing layer 6 is at least partially cured to form a veneered building panel 11.

The thermosetting binder and the urea of the front layer 2 and the components of the backing layer 6 may be cured by in-line polymerization, meaning that polymerization of components occurs in the production line, during production of the building panel.

The front-layer veneer 3 and the backing-layer veneer 9 are adhered to the substrate 1 by means of the binders in the front layer 2 and the backing layer 6, respectively, such that a veneered building panel 11 is formed. During the pressing, the binder in the front layer 2 protrudes into the front-layer veneer 3. When the binder has hardened or cured, the front-layer veneer 3 is fixed against the substrate 1. During pressing, the binder in the backing layer 6 protrudes into the backing-layer veneer; and when the binder has hardened or cured, the backing-layer veneer 9 is fixed against the substrate 1.

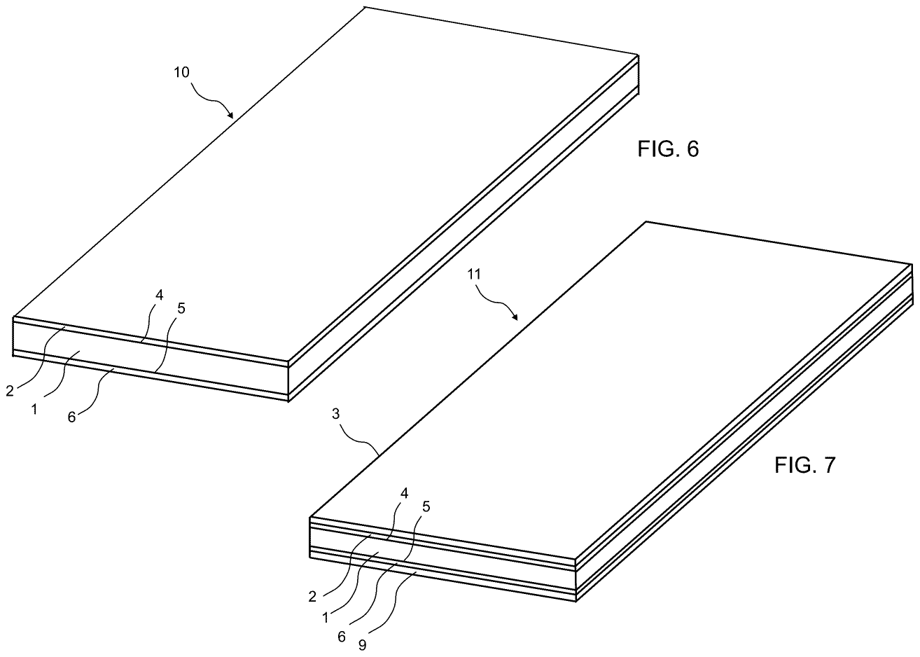

After pressing, a building panel is formed. The building panel includes a substrate 1, a front layer 2, optionally a front-layer veneer 3, optionally a backing layer 6 and optionally a backing-layer veneer 9. Different types of pressed building panels 10 and 11 are schematically illustrated in FIGS. 6 and 7 respectively.

The building panels 10 and 11 may be processed from a larger panel board (not illustrated), e.g. by cutting the larger panel board into individual building panels.

The building panels 10 and 11 may be provided with a mechanical locking system (not illustrated).

The building panels 10 and 11 may be a floor panel, a furniture component, a worktop, a wall panel, a ceiling panel or similar.

FIG. 6 shows a building panel 10 comprising a substrate 1, a front layer 2 arranged on a front surface 4 of the substrate 1. The front layer 2 comprises melamine-residues, formaldehyde-residues and urea-residues, and the melamine-residues, formaldehyde-residues and urea-residues are at least partially polymerized.

The building panel 10 may further comprise a backing layer 6 arranged on a back surface 5 of the substrate 1 opposite from the first surface 4. The backing layer 6 may comprise melamine-residues, formaldehyde-residues and urea-residues, and the melamine-residues, formaldehyde-residues and urea-residues may be at least partially polymerized.

A binder in the backing layer 6 may be the same as a binder in the front layer 2. The backing layer 6 may be a balancing layer or counteracting layer applied in order to balance the building panel 10.

The appearance of the finished building panel is affected by the particle size of the urea used to produce the building panel. By choosing an appropriate particle size of the urea powder, particles and/or aggregates of urea causing discoloration of the building panel may be avoided. Such discolorations may be seen as white spots on building panels without a veneer. Urea particles with a size of approximately 500 mm or more, or even 250 mm or more may cause discolorations.

The front layer 2 of the building panel 10 may be free from any discolorations from urea particles and/or urea aggregates.

The emission of free formaldehyde from the heating and pressing step, when producing building panels, is significantly reduced when producing building panels and veneered building panels according to the embodiments of the method of the present disclosure, compared to conventional pressing methods for pressing building panels comprising thermosetting binders, such as melamine-formaldehyde binders. However, also the emission of formaldehyde from the finished building panel is reduced.

According to TSCA, Title VI (2018) there are different formaldehyde emission limits for different composite wood products, in order for them to be classified as an ultra-low emitting formaldehyde (ULEF) product. For example, the formaldehyde emission limit is 0.11 ppm for a product comprising an MDF board with a thickness of more than 8 mm and 0.13 ppm for a product comprising an MDF board with a thickness of less than or equal to 8 mm. The formaldehyde emission limits refer to formaldehyde emissions as measured in accordance with ASTM 1333.

The building panel 10 may be processed from a larger panel board (not illustrated), e.g. by cutting the larger panel board into individual building panels.

The building panel 10 may be provided with a mechanical locking system (not illustrated).

The building panel 10 may be a floor panel, a furniture component, a worktop, a wall panel, a ceiling panel.

FIG. 7 shows a veneered building panel 11 comprising a substrate 1, a front layer 2 arranged on a front surface 4 of the substrate 1 and additionally a front-layer veneer 3. The front layer 2 comprises melamine-residues, formaldehyde-residues and urea-residues, and the melamine-residues, formaldehyde-residues and urea-residues, are at least partially polymerized. The front-layer veneer 3 may comprise one or more of a wood veneer, an impregnated paper, an unimpregnated paper, or a fabric such as a woven or a nonwoven fabric. In other embodiments, the front-layer veneer 3 may comprise a cork veneer layer, a multiple paper layer, a polymer-based layer, a textile-based layer, a polymer-based sheet or foil, or similar.

The veneered building panel 11 may further comprise a backing layer 6 arranged on a back surface 5 of the substrate 1 opposite from the first surface 4. The backing layer 6 may comprise melamine-residues, formaldehyde-residues and urea-residues, and the melamine-residues, formaldehyde-residues and urea-residues, may be at least partially polymerized. A binder in the backing layer 6 may be the same as a binder in the front layer 2.

The veneered building panel 11 may additionally comprise a backing-layer veneer 9 arranged on the backing layer 6. The backing layer veneer 9 may comprise one or more of a wood veneer, an impregnated paper, an unimpregnated paper, or a fabric such as a woven or a nonwoven fabric. In other embodiments, the backing layer veneer 9 may comprise a cork veneer layer, a multiple paper layer, or similar.

If the backing layer veneer 9 is a wood veneer backing layer, it is adhered to the substrate 1 by means of a backing layer 6, as described above with reference to the front layer 2 and front-layer veneer 3. If the backing layer veneer 9 is a wood veneer backing layer, the description and properties of the front-layer veneer 3 also applies to the backing layer veneer 9.

The backing layer 6 and/or the backing layer veneer 9 may be a balancing layer or counteracting layer applied in order to balance the veneered building panel 11.

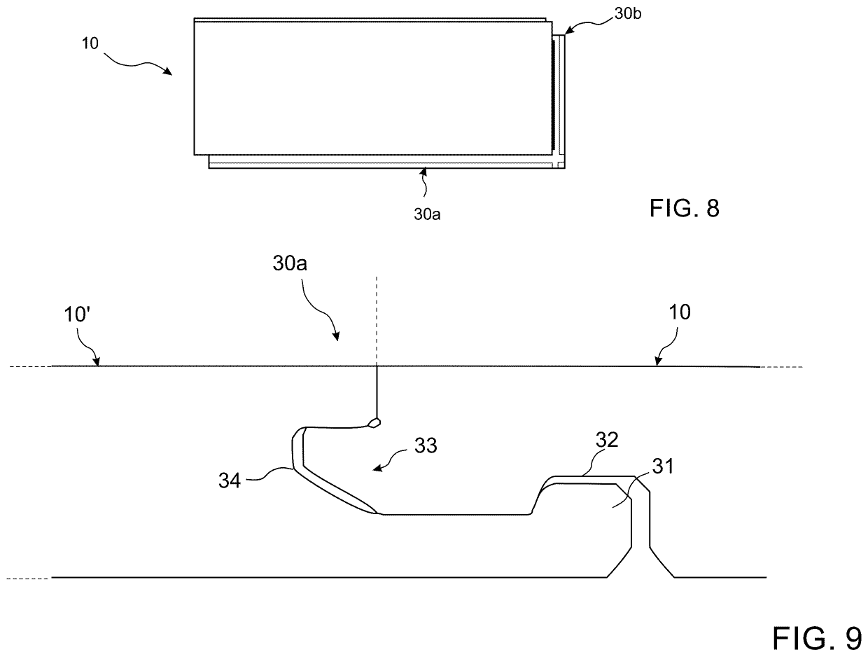

The appearance of the finished building panels may be affected by the particle size of the urea used to produce the building panel. By choosing an appropriate particle size of the urea powder, particles and/or aggregates of urea causing discoloration of the building panel may be avoided. Such discolorations may be seen as white spots in open structures of veneered building panels and as dark spots under the veneer of veneered panels. Urea particles with a size of approximately 500 mm or more, or even 250 mm or more may cause discolorations. A photograph of a veneered building panel comprising discolorations from urea is shown in FIG. 8. The discolorations are marked with arrows in the photograph.

The front layer 2 and the front-layer veneer 3 of the veneered building panel 11 may be free from any discolorations from urea particles and/or urea aggregates.

The emission of free formaldehyde from the heating and pressing step is significantly reduced when producing building panels and veneered building panels according to the embodiments of the method of the present disclosure, compared to conventional pressing methods for pressing building panels comprising thermosetting binders, such as melamine-formaldehyde binders. However, also the emission of formaldehyde from the finished building panel is reduced.

The U.S. Environmental Protection Agency has established formaldehyde emission standards for different products, as part of the Toxic Substances Control Act (TSCA). According to these standards (TSCA, Title 6, 2018), a veneered building panel comprising a wooden core is classified as an ultra-low emitting formaldehyde (ULEF) hardwood plywood, if the emission of formaldehyde from the panel is less than 0.05 ppm (parts per million), as measured according to ASTM 1333. The formaldehyde-emission from the building panel 11, as measured according to ASTM 1333 may be less than 0.05 ppm (parts per million). The building panel 11 may be classified as an ultra-low emitting formaldehyde (ULEF) hardwood plywood, according to TSCA, title 6 (2018).

The veneered building panel 11 may be processed from a larger panel board (not illustrated), e.g. by cutting the larger panel board into individual building panels.

The veneered building panel 11 may be provided with a mechanical locking system (not illustrated).

The veneered building panel 11 may be a floor panel, a furniture component, a worktop, a wall panel, or a ceiling panel.

A method for producing a building panel 10 will now be described with reference to FIGS. 1, 3 and 4. It is to be noted that the arrows in FIG. 4 represent an illustrative sequence order of steps, and that various steps can be performed in various sequence orders (including overlapping in time) within the scope of the present disclosure. The production method comprises providing 20 a substrate 1. The substrate 1 comprises a first surface 4 and a second surface 5 located opposite the first surface 4.

The substrate 1 is fed along a direction F into a production line comprising a scatter device 14, a heating device 13, and a pressing device 15.

In the scatter device 14, a backing-layer mix 8 may be applied 21 on the back surface 5 of the substrate 1, forming a backing layer 6, as shown in FIG. 3.

Thereafter, the heating device 13 may apply 22 heat and/or moisture on the backing layer 6 in order to form a glue bond between the substrate 1 and the backing layer 6.

The substrate 1 with the attached backing layer 6 may thereafter be turned 23 around. Turning the substrate is preferably done automatically.

A front-layer mix 7 is applied 24 to the second surface 5 of the substrate 1, forming a front layer 2. The heating device 13 may apply 25 heat and/or moisture on the front layer 2 in order to form a glue bond between the substrate 1 and the front layer 2.

A pressing device, embodied as a continuous press 15 having upper 16 and lower 17 belts, applies 26 pressure and heat to the substrate 1 and the thereon arranged front layer 2 and backing layer 6. Thus, a building panel 10, e.g., as shown in FIG. 6 is formed.

The method for producing a building panel 10 shown in FIG. 6 corresponds mainly to the method described with reference to FIGS. 1, 3 and 4.

A method for producing a veneered building panel 11 will now be described with reference to FIGS. 2, 3 and 5. It is to be noted that the arrows in FIG. 5 represent an illustrative sequence order of steps, and that various steps can be performed in various sequence orders (including overlapping in time) within the scope of the present disclosure. The production method comprises providing 20 a substrate 1. The substrate 1 comprises a first surface 4 and a second surface 5 located opposite the first surface 4.

The substrate 1 is fed along a direction F into a production line comprising a scatter device 14, a heating device 13, and a pressing device 15.

In the scatter device 14, a backing-layer mix 8 may be applied 21 on the back surface 5 of the substrate 1, forming a backing layer 6, as shown in FIG. 3.

Thereafter, the heating device 13 may apply 22 heat and/or moisture on the backing layer 6 in order to form a glue bond between the substrate 1 and the backing layer 6.

The substrate 1 with the attached backing layer 6 may thereafter be turned 23 around. Turning the substrate is preferably done automatically.

A front-layer mix 7 is applied 24 to the second surface 5 of the substrate 1, forming a front layer 2. The heating device 13 may apply 25 heat and/or moisture on the front layer 2 in order to form a glue bond between the substrate 1 and the front layer 2. A front-layer veneer 3 may be applied 27 on the front layer and a backing-layer veneer 9 may be applied 27 on the backing layer 9.

A pressing device, embodied as a continuous press 15 having upper 16 and lower 17 belts, applies 28 pressure and heat to the substrate 1 and the thereon arranged front-layer veneer 3, front layer 3, backing layer 6 and backing-layer veneer 9. Thus, a veneered building panel 11, e.g., as shown in FIG. 7 is formed.

The method for producing a building panel 10 shown in FIG. 6 corresponds mainly to the method described with reference to FIGS. 1, 3 and 4. The method for producing a veneered building panel 11 shown in FIG. 7 corresponds mainly to the method described with reference to FIGS. 2, 3 and 5.

FIG. 8 illustrates a top view of a building panel 10 provided with a first mechanical locking device 30a and a second mechanical locking device 30b, in order to assemble similar or essentially identical building panels.

FIG. 9 is a schematic illustration of the first mechanical locking device 30a in the assembled state of two adjacent building panels 10, 10′. The first mechanical locking device 30a comprises a locking element 31, configured to cooperate with a locking groove 32 for horizontal locking.

The first mechanical locking device 30a further comprises a locking tongue 33, configured to cooperate with a tongue groove 34 for vertical locking.

The embodiments have been described in relation to a continuous press 15 having an upper press belt 16 and a lower press belt 17. In other embodiments, a static press may be used. A static press comprises an upper press plate and a lower press plate.

The embodiments of the present disclosure are further illustrated in the following examples, which do not limit the scope of the present disclosure.

### EXAMPLES

### Example 1. Varying Particle Size of Urea

Five HDF substrates having a thickness of 10 mm were provided. Four different powder mixes comprising 45.6% by weight melamine-formaldehyde resin, 40.4% by weight wood fibers, 10% by weight barium sulphate and 4% unreacted urea of particle size according to Table 1 were provided. A reference powder mix without any urea, the resin comprising 45.6% by weight melamine-formaldehyde resin, 40.4% by weight wood fibers and 14% by weight barium sulphate, was also provided. The powder mix was applied in powder form in an amount of approximately 430 g/m² on the back surface of the HDF substrate, thereby forming a backing layer on the HDF substrate. The backing layer was sprayed with approximately 23 g/m² water and heated by means of an IR lamp. The substrate with the backing layer was turned. The powder mix was applied in powder form in an amount of approximately 400 g/m² on the front surface of the HDF substrate, thereby forming a front layer on the HDF substrate. The front layer was sprayed with approximately 23 g/m² water and heated by means of an IR lamp. A birch veneer layer having a thickness of 0.6 mm was provided. The birch veneer layer was applied on the front layer and on the backing layer. The front-layer veneer, the front layer, the HDF substrate, the backing layer and the backing-layer veneer were pressed with a pressure of 50 bar during 30 sec. at 180° C. in a static press using electrical/induction heat. The formaldehyde emission from the pressed building panel was measured in accordance with EN12460-3. The formaldehyde emission from four different building panels comprising urea particles of different size intervals can be seen in Table 1. A reference building panel without any urea was also made, by applying the reference powder mix according to the method described above. Duplicate building panels were made for each urea particle size as well as for the reference building panel, and the formaldehyde emission values in Table 1 are the mean values of the two duplicates. The results of Example 1 are also shown in the diagram in FIG. 8. For illustrative purposes, a linear regression of the datapoints is shown in the diagram in FIG. 8.

TABLE 1

| | | Formaldehyde |
|---|---|---|
| | Urea particle | emission |
| Sample | size (mm) | (mg/m²h) |
| Reference | — | 0.9 |
| sample | | |
| (no urea) | | |
| 1 | 0-50 | 0.38 |
| 2 | 50-100 | 0.43 |
| 3 | 100-250 | 0.48 |
| 4 | >1000 (prills/ | 0.79 |
| | granules) | |

It can be concluded from the results in Table 1 that the formaldehyde emission is lowest for the sample comprising unreacted urea particles with a size of 0-50 mm and highest for the sample comprising unreacted urea particles with a size of >1000 mm, proving the efficiency of small size unreacted urea as a formaldehyde scavenger.

### Example 2. Varying Concentration of Unreacted Urea

Five HDF substrates having a thickness of 10 mm were provided. A powder mix comprising 45.6% by weight melamine-formaldehyde resin, 40.4% by weight wood fibers, a concentration of barium sulphate according to Table 2 and a concentration of unreacted urea according to Table 2 was provided. The powder mix was applied in powder form in an amount of 430 g/m² on the back surface of the HDF substrate, thereby forming a backing layer on the HDF substrate. The backing layer was sprayed with approximately 23 g/m² water and heated by means of an IR lamp. The substrate with the backing layer was turned. The powder mix was applied in powder form in an amount of 400 g/m² on the front surface of the HDF substrate, thereby forming a front layer on the HDF substrate. The front layer was sprayed with approximately 23 g/m² water and heated by means of an IR lamp. A birch veneer layer having a thickness of about 0.6 mm was provided. The birch veneer layer was applied on the front layer and on the backing layer. The front-layer veneer, the front layer, the HDF substrate, the backing layer and the backing-layer veneer were pressed with a pressure of 50 bar during 30 sec. at 180° C. in a press using electrical/induction heat. The formaldehyde emission from the pressed building panel was measured in accordance with EN12460-3. The formaldehyde emission from four different building panels comprising different concentrations of urea can be seen in Table 2. A reference building panel without any urea was also made (the resin comprising 45.6% by weight melamine-formaldehyde resin, 40.4% by weight wood fibers and 14% by weight barium sulphate). Duplicate building panels were made for each urea concentration and the formaldehyde emission values in Table 2 are the mean values of the two duplicates.

TABLE 2

| | Urea | Barium sulphate | Formaldehyde |
|---|---|---|---|
| | concentration | concentration | emission |
| Sample | (wt %) | (wt %) | (mg/m²h) |
| Reference | — | 14 | 0.9 |
| sample | | | |
| (no urea) | | | |
| 1 | 2 | 12 | 0.59 |
| 2 | 4 | 10 | 0.38 |
| 3 | 6 | 8 | 0.25 |
| 4 | 8 | 6 | 0.23 |

The particle size distribution of the urea used in Example 2 was determined with sieving analysis in accordance with ISO 2591-1 and is shown in Table 3 below.

TABLE 3

| Particle size | % by weight |
|---|---|
| urea (mm) | of urea |
| >500 | 1.40 |
| 250-500 | 7.20 |
| 100-250 | 18.70 |
| 50-100 | 46.30 |
| 0-50 | 25.10 |

The formaldehyde emission decreases with increasing concentration of unreacted urea, which can be seen in Table 2. However, if the concentration of unreacted urea exceeds about 5% by weight of the powder mix, some of the technical properties of the building panel, like moisture resistance, may be impaired.

### Example 3. Discoloration of Building Panels Comprising Unreacted Urea with an Enhanced Proportion of High-Size Particles (>500 mm)

A building panel was produced according to the method disclosed in Example 2, except that a powder mix comprising 4 wt % urea, with 3-4 wt % of the urea particles having a particle size >500 mm, was used in the backing layer and in the front layer. The finished building panel was photographed and the photo is shown in FIG. 9.

As can be seen in FIG. 9, the building panel has several dark discolorations from urea particles on the veneer. The discolorations are marked with arrows in FIG. 9. Further on, as shown in FIG. 9, it can be contemplated that (at a total urea concentration of 4 wt % in the powder mix), if the fraction of urea particles with a particle size >500 mm exceeds about 3 wt %, these urea particles may cause discolorations on the building panel. Urea particles with a particle size exceeding 250 mm may most probably also contribute to these discolorations.

### Example 4. Brinell Hardness of a Building Panel Comprising Melamine-Formaldehyde and Unreacted Urea Vs. A Conventional Melamine-Formaldehyde Building Panel

Two different melamine-formaldehyde powder mixes were provided; Mix A was with unreacted urea and Mix B was without urea. The contents of the powder mixes are shown in Table 4 below.

TABLE 4

| | Mix A wt % | Mix B wt % |
|---|---|---|
| Wood fiber | 46.08 | 48 |
| Melamine-formaldehyde | 45.6 | 47.5 |
| Urea | 4.0 | — |
| Inorganic fillers | 4.32 | 4.5 |

A HDF substrate with a thickness of 10 mm was provided. Mix A was applied in powder form in an amount of approximately 500 g/m² on the back surface of the HDF, thereby forming a backing layer. The backing layer was sprayed with approximately 23 g/m² water and heated by means of an IR lamp and the substrate was turned. Mix A was applied in powder form in an amount of approximately 500 g/m² on the front surface of the HDF, thereby forming a front layer. The front layer was sprayed with approximately 23 g/m² water and heated by means of an IR lamp. A birch veneer having a thickness of 0.6 mm was applied on the backing layer and an oak veneer having a thickness of 0.6 mm was applied on the front layer. The front-layer veneer, the front layer, the HDF substrate, the backing layer and the backing-layer veneer were pressed with a pressure of 50 bar during 30 sec. at 180° C. in a static press using electrical/induction heat, forming a building panel. The Brinell hardness of the building panel was measured in accordance with EN1534:2020, and is shown in Table 5 below.

A reference building panel without urea was made using the same method as above, but with Mix B instead of Mix A. Brinell hardness was measured in accordance with EN1534:2020 also for the reference panel, and the results are shown in Table 5 below.

TABLE 5

| | Brinell hardness |
|---|---|
| Building panel | Kgf/mm² |
| Mix A (with urea) | 10.20 |
| Mix B (without urea) | 9.15 |

It can be seen in Table 5 that the building panel made with Mix A in the binder layers has an increased hardness compared to the building panel made with Mix B in the binder layers. Adding unreacted urea to the binder resin thus results in a building panel with an increased Brinell hardness, compared to a building panel made with a resin without urea.

### Example 5. Resin Flow—Flow in “Knots” in Building Panels Comprising a Resin Comprising Melamine-Formaldehyde and Unreacted Urea Vs. In Building Panels Comprising a Conventional Melamine-Formaldehyde Resin

Four different building panels were prepared, according to the method disclosed in Example 4 above, using powder mixes and amounts of binder applied according to Table 6 below. Mix A (with unreacted urea) and Mix B (without urea) were as disclosed in Example 4 above.

TABLE 6

| | | Amount of binder |
|---|---|---|
| Panel | Powder mix | applied (g/m²) |
| 1 | Mix A | 350 |
| 2 | Mix B | 350 |
| 3 | Mix A | 400 |
| 4 | Mix B | 400 |

An artificial “knot” was introduced on each one of the building panels by punching a hole with an approximate diameter of 20 mm in the front oak veneer of the building panels, using a steel punch.

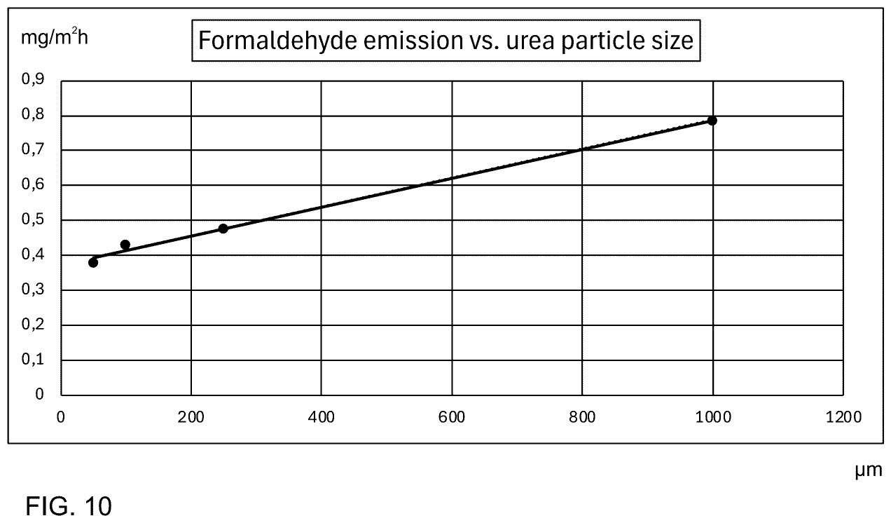

The artificial “knots” on the four building panels were photographed, and the photos are shown in FIG. 10.

In the photos in FIG. 10, the flow of binder in the “knots” can be seen as an irregular edge emerging from the circumference of the “knot” towards the center of the “knot”. The more the edge spreads towards the center of the “knot”, the better is the resin flow of the binder. The intention of this experiment was not to fill the “knots” for a decorative purpose. Instead, the purpose of the experiment was to show the differences in resin flow when using a binder comprising melamine-formaldehyde and unreacted urea compared to a conventional melamine-formaldehyde binder.

As can be seen in FIG. 10, the resin flow is better in panel 1 (with urea) compared to panel 2 (without urea) and better in panel 3 (with urea) compared to panel 4 (without urea). Thus, the inclusion of unreacted urea in powder form in the binder resin improves the resin flow in the building panel. A technical effect of this is that by including unreacted urea in the powder mix, a lower amount of binder can be applied in the binder layer, while the knots of a veneer layer can still be filled satisfactory.

### Example 6. Resin Flow of a Resin Comprising Melamine-Formaldehyde and Unreacted Urea Compared to a Conventional Melamine-Formaldehyde Resin

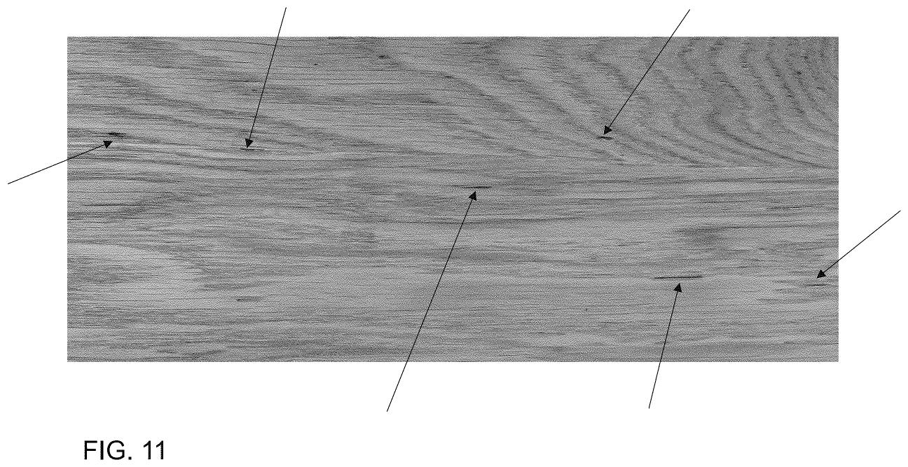

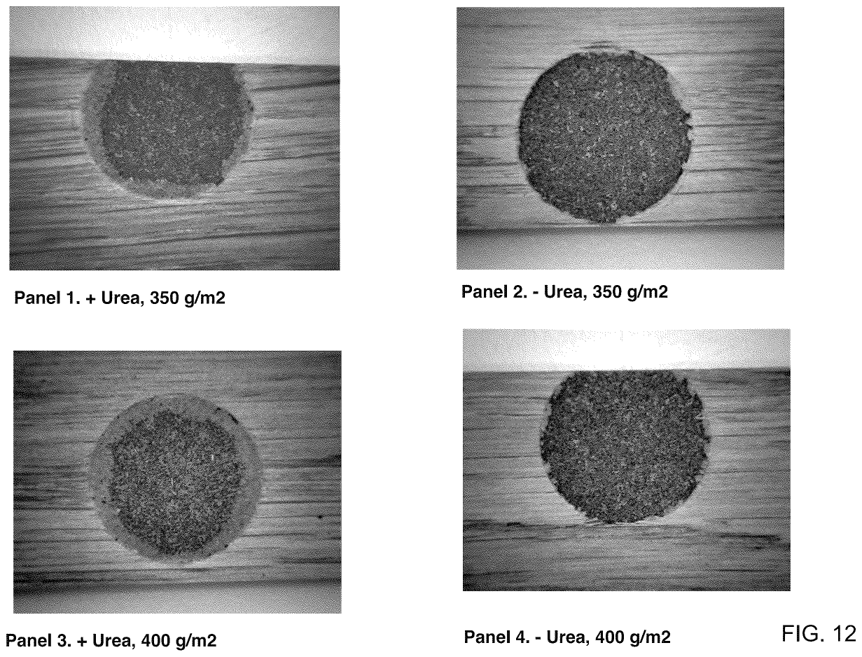

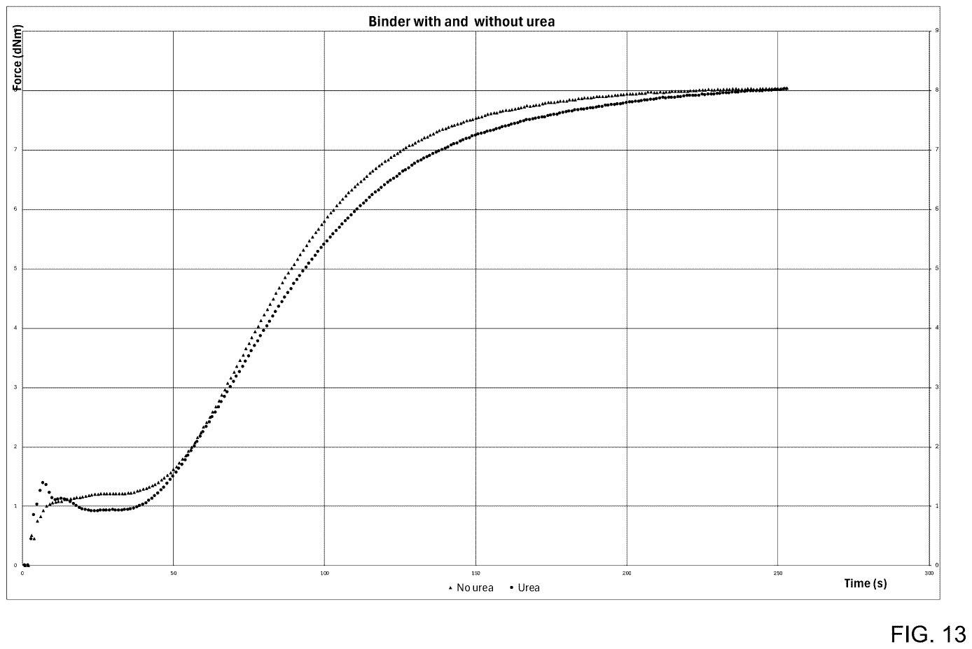

The two powder mixes disclosed in Example 4; Mix A (comprising unreacted urea in powder form) and Mix B (not comprising urea) were tested in an RPA Elite rheometer from TA Instruments. The results of the rheology measurements are shown in FIG. 11. The resin comprising urea initially shows a lower flow (higher force) than the resin without urea. However, after about 10 s, the resin comprising urea has a higher flow (lower force) than the resin without urea. From about 10 s until about 50 s, the resin with urea has a higher flow and it is contemplated that this can be seen as an improved filling of the artificial knots in Example 5.

Accordingly, in order to achieve a satisfying reduction of the formaldehyde emission, and at the same time a building panel with good technical properties and a visually appealing design, it may be advantageous to keep the particle size of the urea under 250 mm or at least under 500 mm and to limit the urea concentration to maximum about 5% by weight in the binder powder formulation.

It is further noted that building panels made with unreacted urea of the right particle size and concentration in the resins used in the binder layers of the panels have an increased hardness and a better resin flow, compared to conventional building panels made without unreacted urea in powder form in the resins used in the binder layers.

### Items.

1. A method for producing a building panel comprising:
   providing a substrate (1),
providing a front-layer mix (7) comprising a thermosetting binder in powder form and unreacted urea in powder form,
applying said front-layer mix (7) on a front surface (4) of the substrate (1), thereby forming a front layer (2), and
thereafter applying heat and pressure to the front layer (2) and the substrate (1), thereby at least partially curing the thermosetting binder and the urea, to form said building panel.
2. The method according to item 1, wherein the front-layer mix (7) is applied in powder form.
3. The method according to item 1, wherein the front-layer mix (7) is applied as a granulate.
4. The method according to any of the items 1-3, wherein the front-layer mix (7) comprises an amino resin, such as a melamine-formaldehyde resin.
5. The method according to any of the preceding items, further comprising applying a front-layer veneer (3) on the front-layer (2), wherein applying heat and pressure comprises applying heat and pressure to the front-layer veneer (3), the front layer (2) and the substrate (1).
6. The method according to item 5, wherein the front-layer veneer comprises one or more of a wood veneer, an impregnated paper, an unimpregnated paper, and a fabric such as a woven or nonwoven fabric.
7. The method according to any of the preceding items, wherein the front-layer mix (7) comprises unreacted urea with an average particle size of 0-1000 mm, such as 0-500 mm, 0-250 mm, 0-100 mm or 0-50 mm and wherein average particle size is determined with sieving analysis in accordance with ISO 2591-1.
8. The method according to any of the preceding items, wherein the front-layer mix (7) comprises unreacted urea with an average particle size of less than 1000 mm, such as less than 500 mm, less than 250 mm, less than 100 mm or less than 50 mm and wherein average particle size is determined with sieving analysis in accordance with ISO 2591-1.
9. The method according to any of the preceding items, wherein at least 99% by weight of the unreacted urea in the front-layer mix (7) has a particle size of less than 1000 mm, optionally at least 98% by weight of the unreacted urea in the front-layer mix (7) has a particle size of less than 500 mm and/or at least 95% by weight of the unreacted urea in the front-layer mix (7) has a particle size of less than 250 mm, and wherein particle size is determined with sieving analysis in accordance with ISO 2591-1.
10. The method according to any of the preceding items, wherein the front-layer mix (7) comprises one or more of fillers, pigments, wear-resistant particles, lignocellulosic materials, and other additives.
11. The method according to any of the preceding items, wherein the front-layer mix (7) comprises 0.1-10%, such as 0.5-8%, 1-6% or 2-5% by weight of urea.
12. The method according to any of the preceding items, wherein the front-layer mix (7) comprises 20-70%, such as 30-60%, or 40-50% by weight of a thermosetting binder.
13. The method according to any of the preceding items, wherein the front-layer mix (7) comprises 10-60% %, such as 20-50%, or 35-45% by weight of lignocellulosic material, such as wood fibers, hemp, grass, flax, straw and/or bagasse.
14. The method according to any of the preceding items, wherein the substrate (1) is a wood-based board, such as an MDF board, a HDF board, a plywood, or a particle board.
15. The method according to any of the preceding items, further comprising applying a backing-layer mix (8) to a back surface (5) of the substrate (1) opposite the front surface (4) on which the front-layer mix (7) is applied, thereby forming a backing layer (6), and
   thereafter applying heat and pressure to the front layer (2), the substrate (1) and the backing layer (6).
16. The method according to item 15 wherein the backing-layer mix (8) comprises a thermosetting binder in powder form and unreacted urea in powder form.
17. The method according to item 15 or 16, wherein a binder in the backing-layer mix (8) is the same as a binder in the front-layer mix (7).
18. The method according to any of the items 15-17, wherein the backing-layer mix (8) comprises unreacted urea with an average particle size of 0-1000 mm, such as 0-500 mm, 0-250 mm, 0-100 mm or 0-50 mm and wherein average particle size is determined with sieving analysis in accordance with ISO 2591-1.
19. The method according to any of the items 15-18, wherein the backing-layer mix (8) comprises unreacted urea with an average particle size of less than 1000 mm, such as less than 500 mm, less than 250 mm, less than 100 mm or less than 50 mm and wherein average particle size is determined according to ISO 2591-1.
20. The method according to any of the items 15-19, at least 99% by weight of the unreacted urea in the backing-layer mix (8) has a particle size of less than 1000 mm, optionally at least 98% by weight of the unreacted urea in the backing-layer mix (8) has a particle size of less than 500 mm and/or at least 95% by weight of the unreacted urea in the backing-layer mix (8) has a particle size of less than 250 mm, and wherein particle size is determined with sieving analysis in accordance with ISO 2591-1.
21. The method according to any of the items 15-20 wherein the method further comprises applying a backing-layer veneer (9), on the backing layer (6), wherein applying heat and pressure comprises applying heat and pressure to the front-layer veneer (3), the front layer (2), the substrate (1), the backing layer (6), and the backing-layer veneer (9).
22. The method according to item 21, wherein the backing-layer veneer (9) comprises one or more of a wood veneer, an impregnated paper, an unimpregnated paper, and a fabric such as a woven or nonwoven fabric.
23. The method according to any of the preceding items, wherein the heat applied in the heating and pressing step is 100-250° C. and/or the pressure applied in the heating and pressing step is at least 25 bar. 24. A building panel (10) produced with the method according to any of the items 1-23.
25. A building panel (10), comprising:
a substrate (1), and
a front layer (2) arranged on a front surface (4) of the substrate (1),
wherein the front layer (2) comprises melamine-residues, formaldehyde-residues and urea-residues, and wherein said melamine-residues, formaldehyde-residues and urea-residues, are at least partially polymerized.
26. The building panel according to item 25, wherein said building panel additionally comprises a front-layer veneer (3) arranged on the front layer (2).
27. The building panel according to item 26, wherein the front-layer veneer (3) comprises one or more of a wood veneer, an impregnated paper, an unimpregnated paper, and a fabric such as a woven or nonwoven fabric.
28. The building panel according to any of the items 25-27, wherein said building panel (10) additionally comprises a backing layer (6) arranged on a back surface (5) of the substrate (1), opposite from the first surface (4).
29. The building panel according to item 28, wherein the backing layer (6) comprises melamine-residues, formaldehyde-residues and urea-residues, and wherein said melamine-residues, formaldehyde-residues and urea-residues, are at least partially polymerized.
30. The building panel according to item 28 or 29, wherein a binder in the front layer (2) is the same as a binder in the backing layer (6).
31. The building panel according to any of the items 28-30, wherein said building panel additionally comprises a backing-layer veneer (9) arranged on the backing layer (6).
32. The building panel according to any of the items 24-31, wherein the formaldehyde emission from the building panel, as measured in accordance with ASTM 1333 is less than 0.05 ppm.
33. The building panel according to any of the items 24-32, wherein said building panel is classified as an ultra-low emitting formaldehyde hardwood plywood, in accordance with TSCA, Title VI (2018).
34. The building panel according to any of the items 24-33, wherein the front layer (2) and the front-layer veneer (3) are substantially free from discolorations from urea particles and/or urea aggregates.
35. Use of unreacted urea as a formaldehyde scavenger in production of building materials, such as building panels, wherein the urea is provided in powder form and has an average particle size of less than 1000 mm, such as less than 500 mm, less than 250 mm, less than 100 mm, or less than 50 mm, and wherein particle size is determined according to ISO 2591-1.

1. A method for producing a building panel, the method comprising:
providing a substrate;
providing a front-layer mix comprising a thermosetting binder in powder form and unreacted urea in powder form;
applying said front-layer mix on a front surface of the substrate, thereby forming a front layer; and
after the applying of said front-layer mix, applying heat and pressure to the front layer and the substrate, thereby at least partially curing the thermosetting binder and the urea, to form said building panel.

2. The method according to claim 1, wherein the front-layer mix is applied in powder form.

3. The method according to claim 1, wherein the front-layer mix is applied as a granulate.

4. The method according to claim 1, wherein the thermosetting binder in the front-layer mix comprises an amino resin.

5. The method according to claim 1, further comprising applying a front-layer veneer on the front-layer, wherein applying heat and pressure comprises applying heat and pressure to the front-layer veneer, the front layer and the substrate.

6. The method according to claim 5, wherein the front-layer veneer comprises one or more of a wood veneer, an impregnated paper, an unimpregnated paper, and a fabric.

7. The method according to claim 1, wherein the front-layer mix comprises urea with an average particle size of 0-1000 mm, wherein average particle size is determined with sieving analysis in accordance with ISO 2591-1.

8. The method according to claim 1, wherein the front-layer mix comprises urea with an average particle size of less than 1000 mm, wherein average particle size is determined with sieving analysis in accordance with ISO 2591-1.

9. The method according to claim 1, wherein at least 99% by weight of the urea in the front-layer mix has a particle size of less than 1000 mm, optionally at least 98% by weight of the unreacted urea in the front-layer mix has a particle size of less than 500 mm and/or at least 95% by weight of the unreacted urea in the front-layer mix has a particle size of less than 250 mm, and wherein particle size is determined with sieving analysis in accordance with ISO 2591-1.

10. The method according to claim 1, wherein the front-layer mix comprises one or more of fillers, pigments, wear-resistant particles, lignocellulosic materials, and other additives.

11. The method according to claim 1, wherein the front-layer mix comprises 0.1-10% by weight of urea.

12. The method according to claim 1, wherein the weight ratio between the urea and the thermosetting binder in the front layer mix is between 1:8 and 1:20.

13. The method according to claim 1, wherein the substrate is a wood-based board.

14. The method according to claim 1, further comprising:
applying a backing-layer mix to a back surface of the substrate opposite the front surface on which the front-layer mix is applied, thereby forming a backing layer; and
after the applying of said backing-layer mix, applying heat and pressure to the front layer, the substrate and the backing layer.

15. The method according to claim 14, wherein the backing-layer mix comprises a thermosetting binder in powder form and unreacted urea in powder form.

16. The method according to claim 14, wherein the method further comprises applying a backing-layer veneer, on the backing layer, wherein applying heat and pressure comprises applying heat and pressure to the front layer, the substrate, the backing layer, and the backing-layer veneer.

17. The method according to claim 1, wherein the heat applied in the heating and pressing step is 100-250° C. and/or the pressure applied in the heating and pressing step is at least 5 bar.

18. A building panel, comprising:
a substrate; and
a front layer arranged on a front surface of the substrate;
wherein the front layer comprises melamine-residues, formaldehyde-residues and urea-residues, and wherein said melamine-residues, formaldehyde-residues and urea-residues are at least partially polymerized.

19. The building panel according to claim 18, wherein said building panel additionally comprises a front-layer veneer arranged on the front layer.

20. The building panel according to claim 18, wherein the formaldehyde emission from the building panel, as measured in accordance with ASTM 1333 is less than 0.05 ppm.

21. The building panel according to claim 18, wherein said building panel is classified as an ultra-low emitting formaldehyde hardwood plywood, in accordance with TSCA, Title VI.

22. The building panel according to claim 18, wherein the front layer and/or the front-layer veneer are substantially free from discolorations from urea particles and/or urea aggregates.

23. A method comprising using unreacted urea as a formaldehyde scavenger in production of building materials, wherein the urea is provided in powder form and has an average particle size of less than 1000 mm, wherein particle size is determined with sieving analysis in accordance with ISO 2591-1.
